(19) United States
(12) Patent Application Publication
(10) Pub. No.: US 2006/0230797 A1
(43) Pub. Date: Oct. 19, 2006

(54) Key core

(76) Inventors: Robert Strong, Indianapolis, IN (US); Michael Kessler, Indianapolis, IN (US); Diana Wallner, Indianapolis, IN (US); Samir Yassine, Indianapolis, IN (US); Daniel Teixeira, Indianapolis, IN (US); Meisara Tansari, Sunnyside, NY (US)

Correspondence Address: BAKER & DANIELS LLP, 300 NORTH MERIDIAN STREET, SUITE 2700, INDIANAPOLIS, IN, 46204, US

(21) Appl. No.: 11/302,931

(22) Filed: Dec. 14, 2005

Related U.S. Application Data
(60) Provisional application No. 60/635,839, filed on Dec. 14, 2004.

(51) Int. Cl. E05B 9/04

(52) U.S. Cl. 70/371

(57) ABSTRACT

Exemplary key cores (10, 110) and keys (12, 112) are disclosed. The keys (12, 112) include extensions or fingers (18, 118) that interact with the key cores (10, 110).

This application claims priority to U.S. Provisional Patent Application Serial No. 60/635,939, titled “Key Core,” filed Dec. 14, 2004, to Strong et al., the disclosure of which is expressly incorporated by reference herein.

### BACKGROUND AND SUMMARY OF THE INVENTION

The present invention relates to locks. More particularly, the present invention relates to a key and key core for a lock.

According to one aspect of the present invention, a key core and lock combination are provided. The key includes an extension that cooperates with the key core to permit the key core to unlock.

According to another aspect of the invention, a key having an extension is provided.

According to one aspect of the present invention, a key and lock core combination is provided that includes a lock core and a key. The lock core includes a sleeve defining an interior region, a plug member positioned in the interior region to move relative to the sleeve, the plug member defining a key passage, and a blocking member positioned to move between a first position blocking movement of the plug member relative to the sleeve and a second position permitting movement of the plug member relative to the sleeve. The key includes a key having a key shank, a bow, and an extension cooperating with the key shank to define a space therebetween. The extension moves the blocking member to the second position when the key shank is inserted into the key passage.

According to another aspect of the present invention, a key for use with a lock core including a key passage is provided. The key includes a key shank having longitudinal grooves extending a majority of the length of the key shank, a key bow coupled to the key shank, and an extension coupled to the key shank. The extension extends in the direction of the key shank and cooperates with the key shank to define a space therebetween.

According to another aspect of the present invention, a key for use with a lock core including a key passage is provided. The key includes a key shank, a key bow coupled to the key shank and having a width substantially equal to a width of the key shank, and an extension coupled to the key shank. The extension extends in the direction of the key shank and cooperates with the key shank to define a space therebetween.

Additional features of the disclosure will become apparent to those skilled in the art upon consideration of the following detailed description when taken in conjunction with the accompanying drawings.

### BRIEF DESCRIPTION OF THE DRAWINGS

A detailed description particularly refers to the accompanying figures in which:

FIG. 1 is an assembly view of an interchangeable key core and a key showing the key core including a key plug, a core sleeve positioned to receive the key plug, a core body positioned to receive the key plug and core sleeve, and a stop clip positioned above the key plug;

FIG. 2 is a view similar to FIG. 1;

FIG. 3 is a perspective view of portions of the key blank and key plug and the stop clip showing the stop clip including a pair of downwardly extending posts and a ledge and the key plug including a pair of apertures to receive the posts;

FIG. 4 is a perspective view of a face plate ring of the key core, the stop clip, and a portion of the key blank showing the face plate ring including a ramp or peak positioned between two valleys or recesses, the ramp holding the stop clip in a down position, and the key blank including a finger positioned above the ledge of the stop clip;

FIG. 5 is a view similar to FIG. 4;

FIG. 6 is a perspective view of the stop clip of FIG. 1;

FIG. 7 is a perspective view of a portion of the key plug of FIG. 1;

FIG. 8; is a perspective view of the face plate ring showing the valleys extending between the ramp and a pair of shoulders;

FIG. 9 is a perspective view of a portion of the key of FIG. 1;

FIG. 10 is another perspective view of a portion of the key plug of FIG. 1;

FIG. 11 is an assembly view of an alternative embodiment key core and a key showing the key core including a key plug, a core sleeve positioned to receive the key plug, a core body positioned to receive the key plug and core sleeve, and a stop clip positioned above the key plug;

FIG. 12 is a perspective view of portions of the key, key plug, face plate, and the stop clip partially positioned in the key plug;

FIG. 13 is another perspective view similar to FIG. 12 showing a back side of the face plate including a pair of valleys and a peak positioned between the valleys;

FIG. 14 is an end view of the key core and key of FIG. 11;

FIG. 15 is a cross-sectional view of the key core and key taken along line 15-15 of FIG. 14;

FIG. 16 is a side elevation view of the stop clip;

FIG. 17 is an end view of the stop clip;

FIG. 18 is a side elevation view of the key of FIG. 11;

FIG. 19 is an end view of the face plate of the key core of FIG. 11;

FIG. 20 is a side elevation view of the face plate of FIG. 11; and

FIG. 21 rear end view of the face plate of FIG. 11.

### DETAILED DESCRIPTION OF THE DRAWINGS

According to the present disclosure, a key core 10 is provided to facilitate retracting or extending of a latch bolt and/or deadbolt of a mortise lock, releasing of the shank of a padlock, or unlocking, locking, releasing or other movement of various locks. Additional disclosure of such locks is provided in U.S. patent application Ser. No. 60/610,639, to Hickman et al., entitled Mortise Lock, U.S. Pat. No. 4,424,693, to Best et al., entitled Key-Removable Lock Core, U.S. Pat. No. 4,836,001, to Foshee, entitled High Security Lock, and U.S. Pat. No. 6,668,606, to Russell et al., entitled Electronic Token Lock Core, the disclosures of which are incorporated by reference herein.

To unlock such a lock, a user inserts a key 12 is into key core 10. Key core 10 includes a set of pin tumblers (not shown) that verify the accesses rights of the inserted key 12. If key 12 includes the proper bitting (ex. see bitting shown in phantom in FIG. 18 for key 112), the pin tumblers of key core 10 will properly align in key core 10 to permit operation of the lock. Additional details of key bitting and pin tumblers is provided in U.S. Pat. Nos. 4,424,693; 4,836,001; 5,136,869; and 6,668,606, the disclosures of which are expressly incorporated by reference herein.

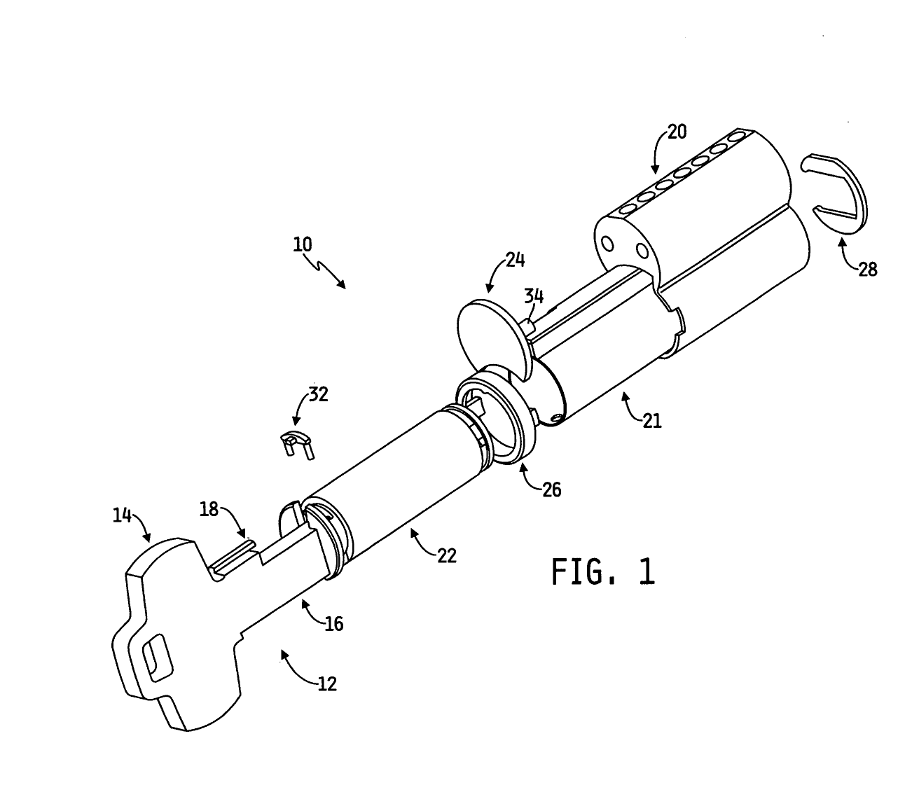

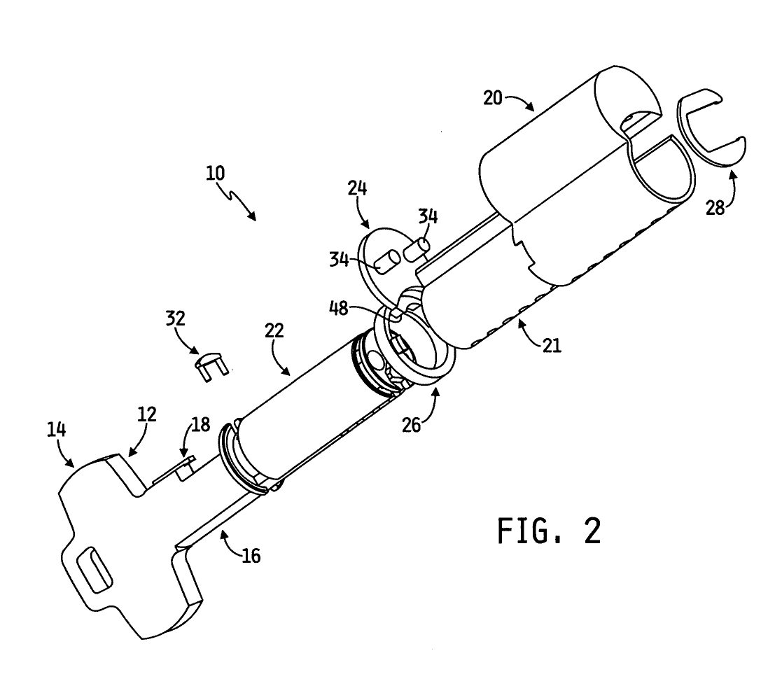

In addition the pin tumblers, key core 10 includes a secondary system, that verifies the access rights of key 12. As shown in FIG. 1, key 12 includes a bow 14, key blade 16, and an extension, protrusion, or finger 18 coupled to blade 16. Finger 18 interacts with key core 10 to enable operation of the lock. If a key without finger 18 is inserted into key core 10, the secondary system will block operation of key core 10.

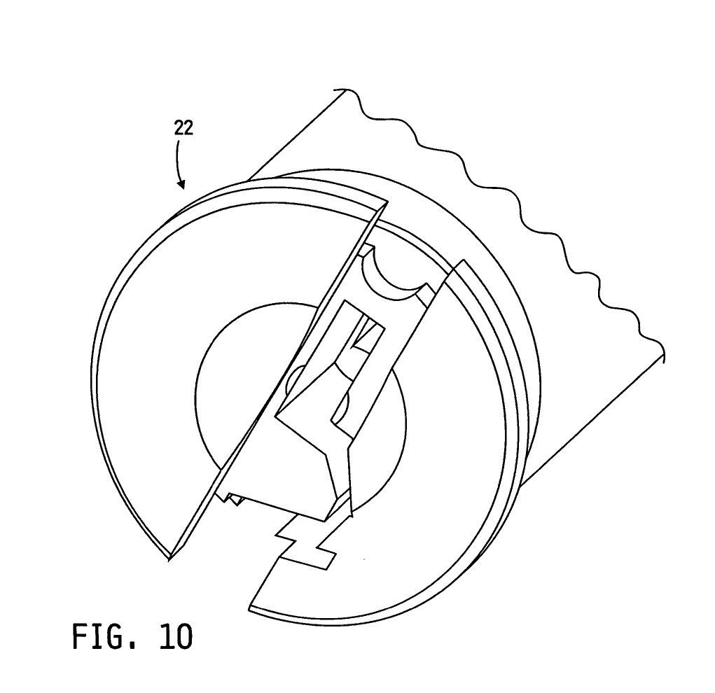

As shown in the figures, key 12 is a blank. Before use, blade 16 is milled, ground, or otherwise machined to include bitting matching the pin tumbler arrangement of key core 10. Blade 16 is provided with a profile including longitudinal grooves to match the profile of the key-receiving opening as shown in FIG. 10. Key 12 may also be profiled to match the profile of other key-receiving openings, such as those show in the previously referenced U.S. patents.

As shown in FIG. 1, key core 10 includes a “figure-8” core body 20, core sleeve 21, key plug 22, face plate 24, face plate ring 26, retaining clip 28, and stop clip 32. During assembly, key plug 22 is inserted into face plate ring 26 and core sleeve 21 so that face plate ring 26 is positioned flush with the face of key plug 22 and stop clip 32 is positioned between ring 26 and key plug 22. Core sleeve 21 with key plug 22 is inserted through core body 20 so that a portion of key plug 22 extends from the rear of core body 20. Retaining clip 28 is positioned over this portion of key plug 22 to block withdrawal of key plug 22 and core sleeve 21 from core body 20. Face plate 24 is coupled to core body 20 with posts 34 inserted into core body 20. According to alternative embodiments of the present disclosure, the secondary system of the present disclosure may be used in other key core configurations, such as key and knob cores with single shear lines and other key core configurations known to those of ordinary skill in the art.

Stop clip 32 along with ring 26 provide the secondary system that blocks operation of key core 10 if a key without finger 18 is inserted into key core 10. Stop clip 32 and ring 26 are intended to block rotation of key plug 22 if a copied key (not shown) with the proper bitting, but without finger 18, is inserted into key core 10. If a copied key without finger 18 is inserted into key core 10, key plug 22 can initially be rotated with the copied key. But, further rotation is blocked so that key plug 22 does not rotate far enough to unlock the lock.

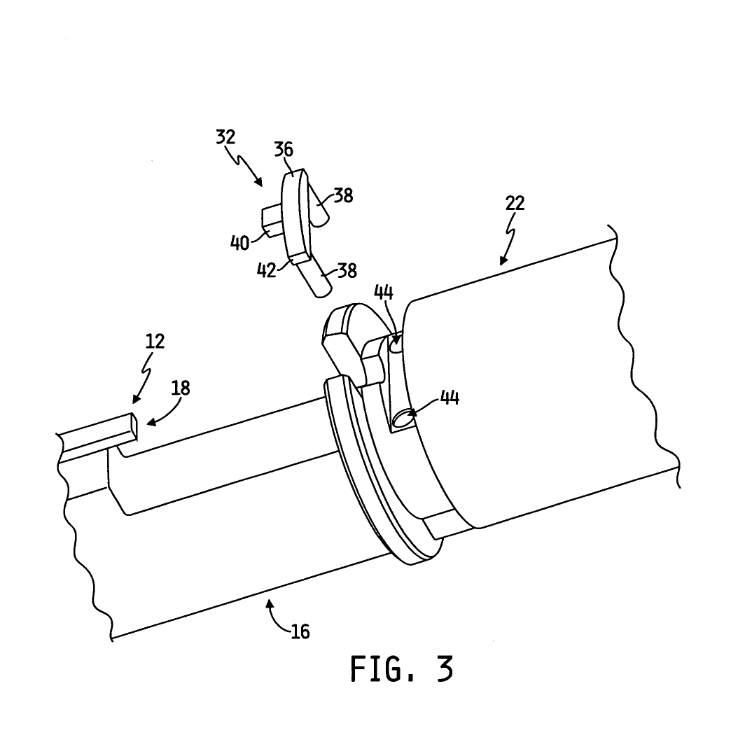

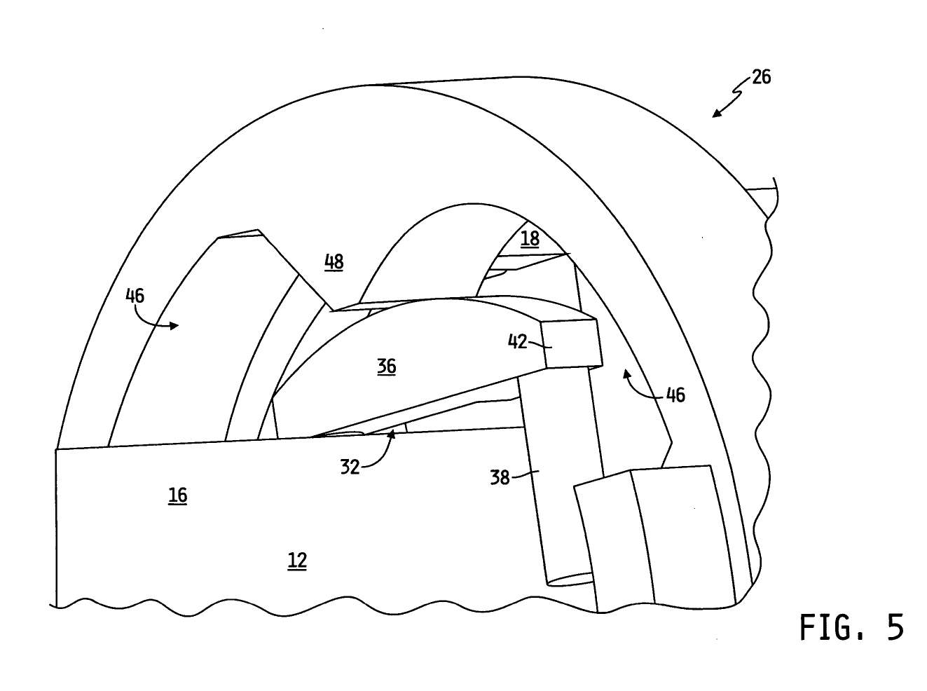

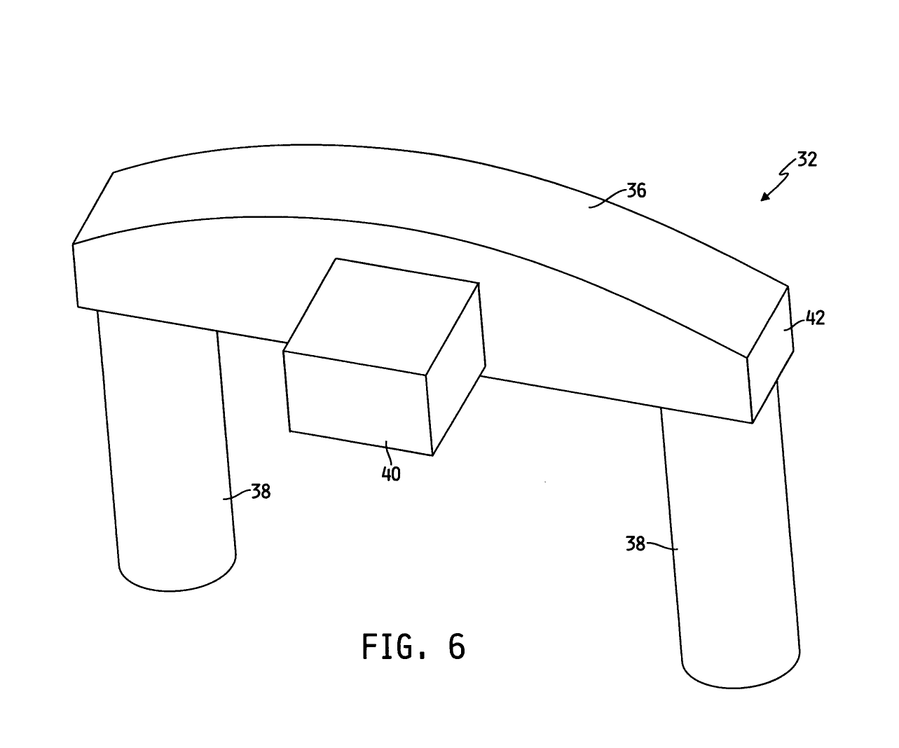

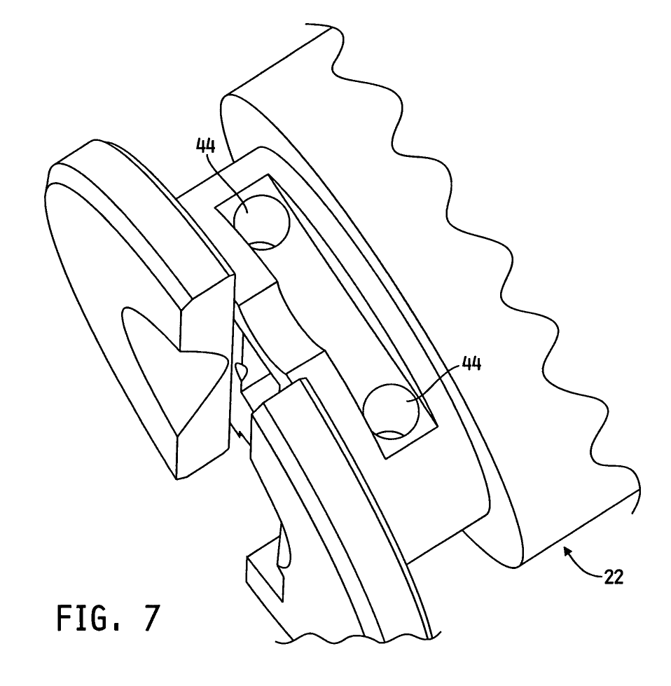

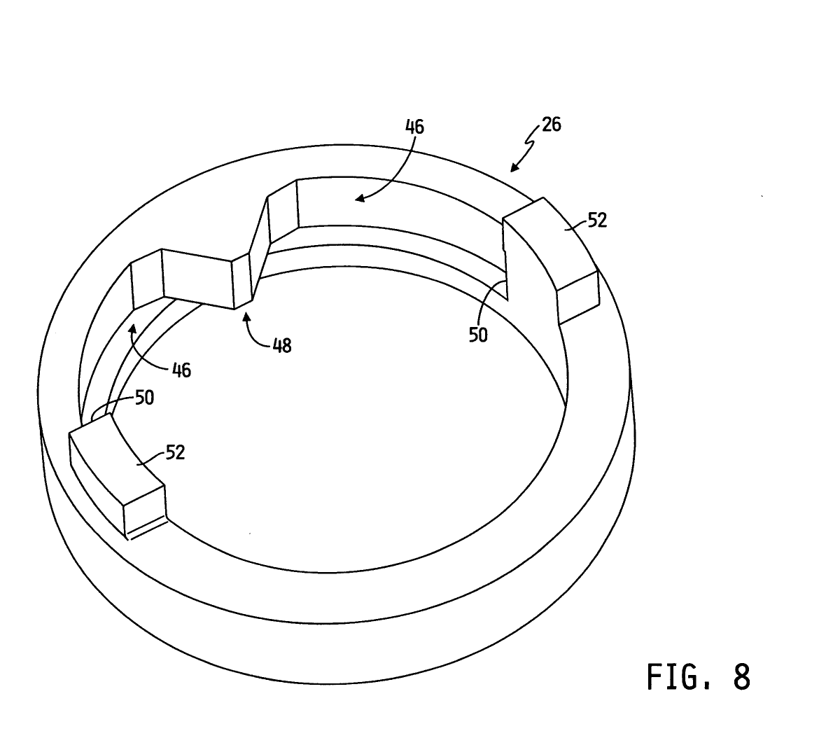

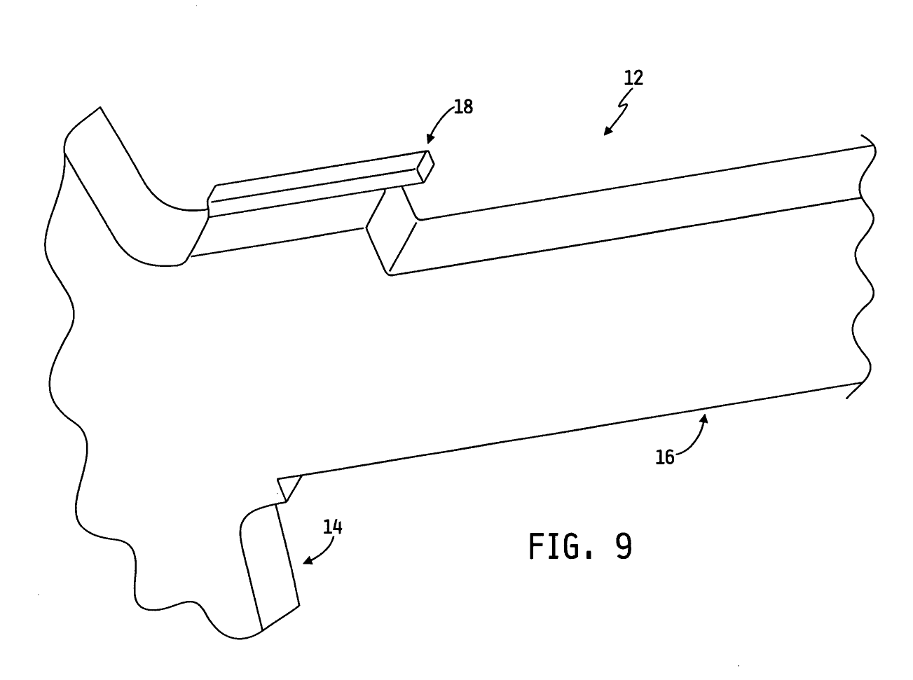

Stop clip 32 interacts with ring 26 to control rotation of key plug 22. As shown in FIG. 6, stop clip 32 includes a fan-shaped body 36, two downwardly extending posts 38, and an outwardly-extending ledge 40. Ends 42 of fan-shaped body 36 are relatively flat. After assembly, posts 38 of stop clip 32 are positioned in apertures 44 of key plug 22 shown in FIGS. 3 and 7. Springs (not shown) positioned in apertures 44 bias stop clip 32 radially outward from key plug 22.

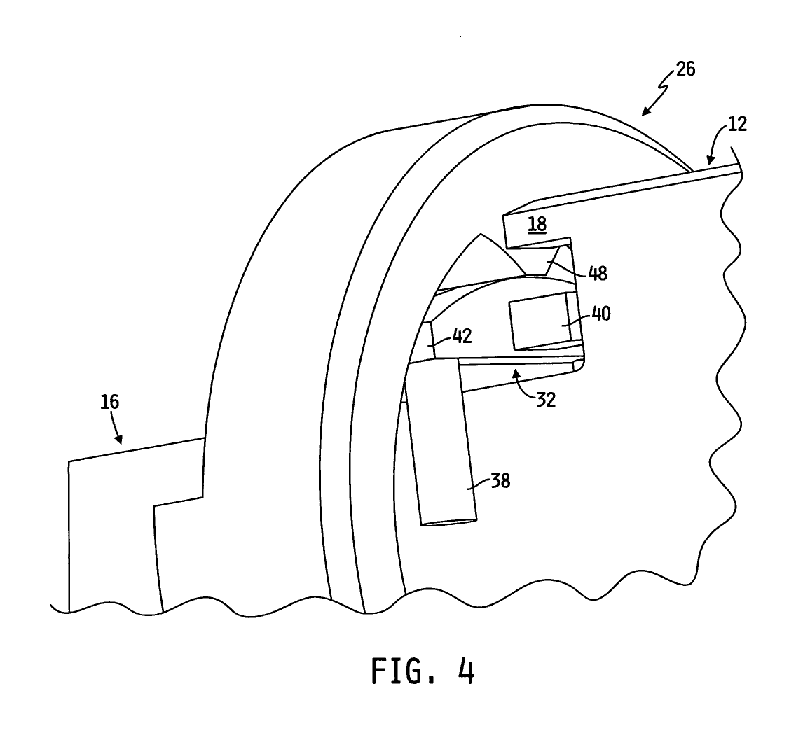

As shown in FIG. 10, a backside of ring 26 includes a pair of depressions or valleys 46 and a ramp 48 positioned between valleys 46. Valleys 46 terminate in shoulders 50 positioned adjacent to positioning lugs 52. When assembled, fan-shaped body 36 of stop clip 32 is positioned under ramp 48 as shown in FIGS. 4 and 5. Ramp 48 pushes down on stop clip 32 and compresses the springs positioned in apertures 44 under posts 38.

When key 12 is inserted into key plug 22, as shown in FIGS. 4 and 5, finger 18 of key 12 is positioned above ledge 40 of stop clip 32. As key 12 rotates, key plug 22 and stop clip 32 rotate relative to ramp 48 of ring 26. During rotation, the springs in apertures 44 push stop clip 32 outwardly until ledge 40 of stop clip 32 engages finger 18 of key 12. Finger 18 prevents stop clip 32 from moving completely into valleys 46. As stop clip 32 continues to rotate with key plug 22 and key 12, finger 18 of key 12 blocks outward movement of stop clip 32 and ends 42 of fan-shaped body 36 of stop clip 32 pass shoulders 50 of ring 26. This permits continued rotation of key plug 22 to unlock the lock.

If a copied key without finger 18 is inserted into key plug 22 and rotated, fan-shaped body 36 of stop clip 32 will slide over ramp 48 into valleys 46. Because finger 18 is not present to block outward movement of stop clip 32, the springs will push fan-shaped body 36 completely into valleys 46 so that ends 42 of stop clip 32 abut shoulders 50 of ring 26 as rotation continues. This contact blocks further rotation of stop clip 32, key plug 22 and key 12 so that the lock is not unlocked. Thus, the copied key without finger 18 will not operate key core 10.

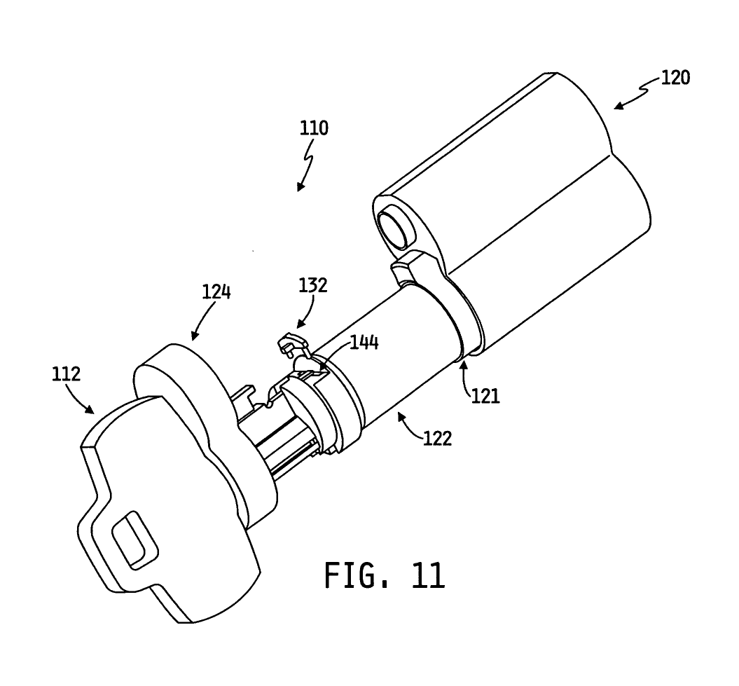

An alternative embodiment key core 110 is shown in FIG. 11 that is similar to key core 10. Key core 110 includes a “figure-8” core body 120, core sleeve 121, key plug 122, face plate 124, retaining clip 128, and stop clip 132. Stop clip 132 along with face plate 124 provide the secondary system that blocks operation of key core 110 if a key without finger 118 is inserted into key core 110.

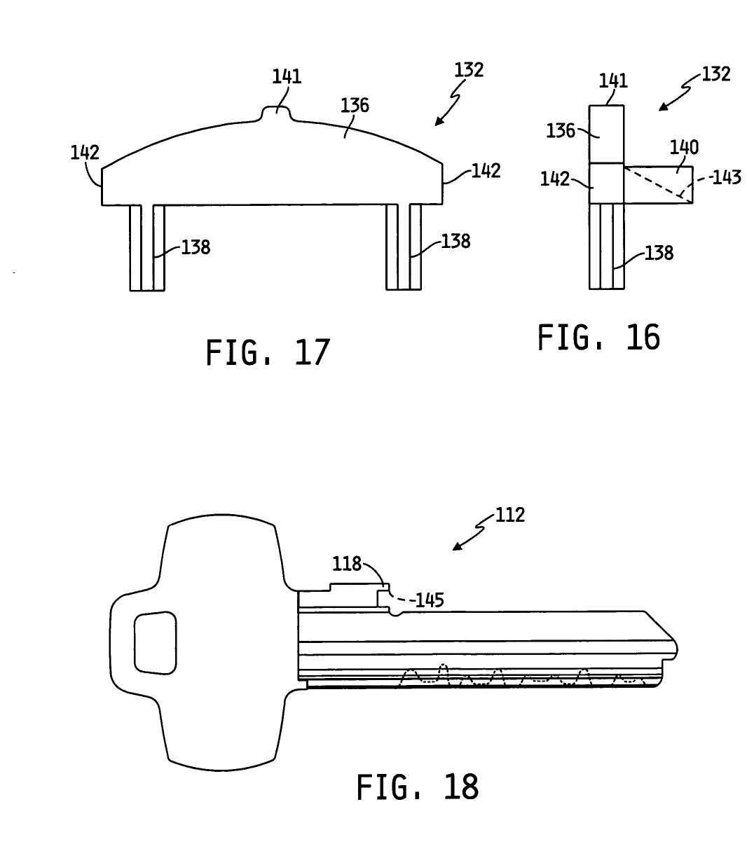

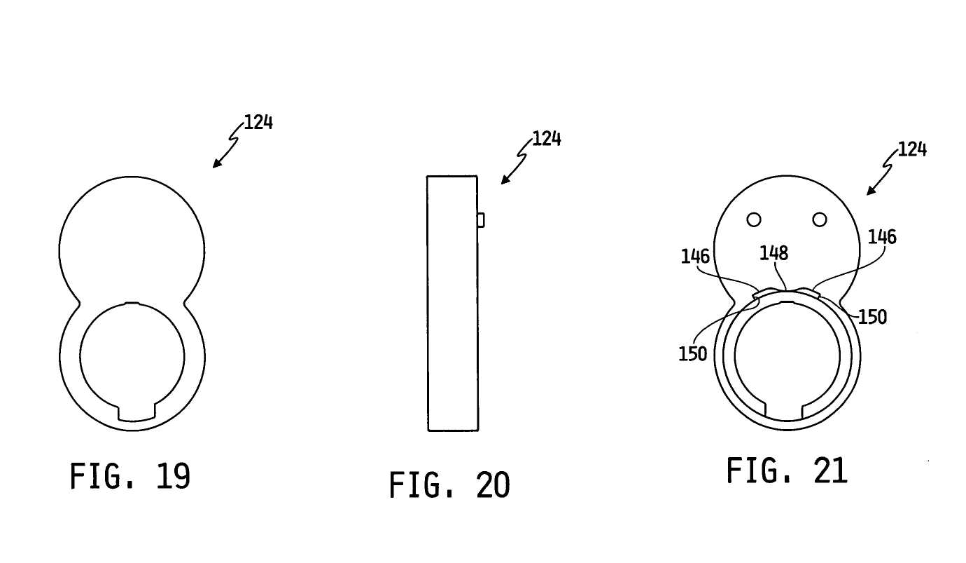

Stop clip 132 interacts with face plate 124 to control rotation of key plug 122. As shown in FIGS. 16 and 17, stop clip 132 includes a fan-shaped body 136, two downwardly extending posts 138, an outwardly-extending ledge 140, and an upwardly extending lug 141. Ends 142 of fan-shaped body 136 are relatively flat. After assembly, posts 138 of stop clip 132 are positioned in apertures 144 of key plug 122 as shown in FIG. 12. Springs (not shown) positioned in apertures 144 bias stop clip 132 radially outward from key plug 122.

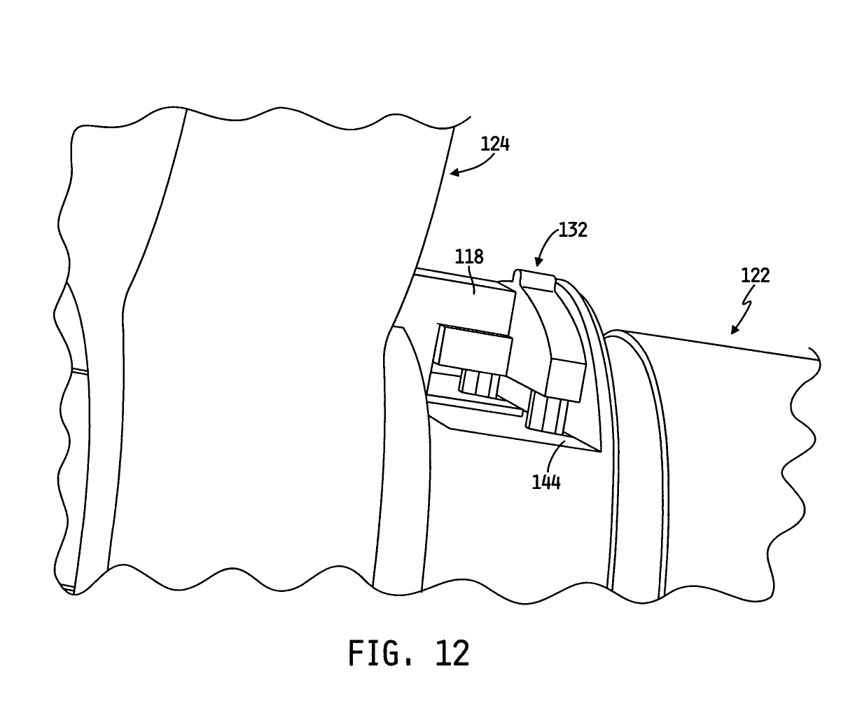

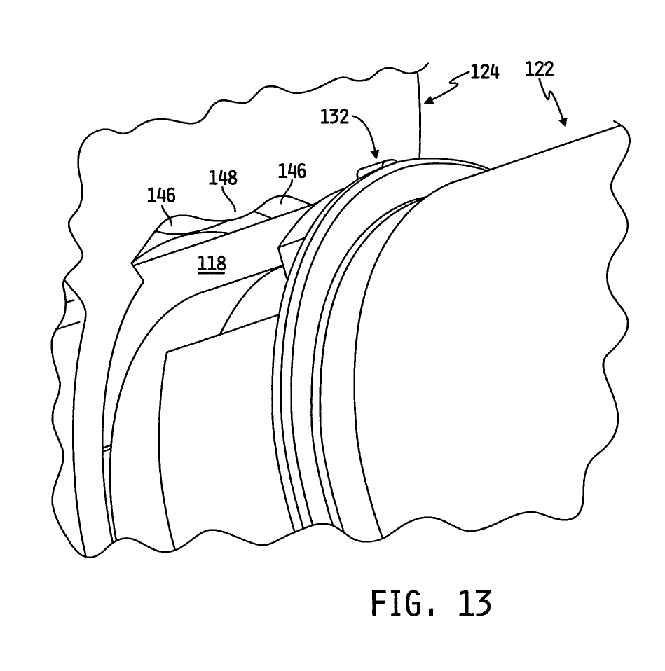

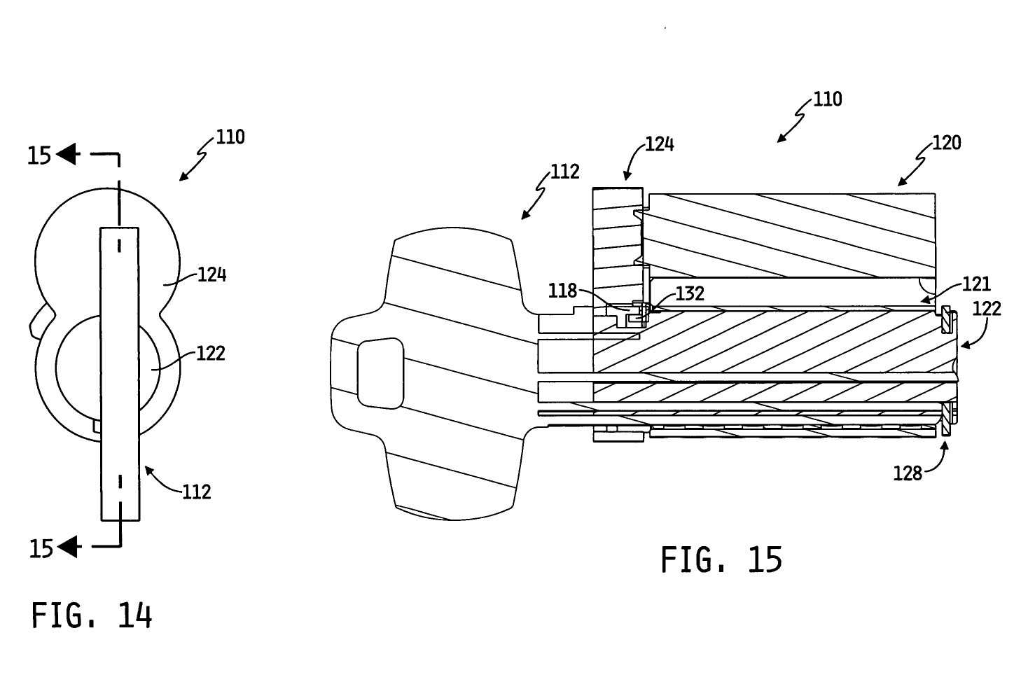

As shown in FIGS. 13 and 21, a backside of face plate 124 includes a pair of depressions or valleys 146 and a ramp 148 positioned between valleys 146. Valleys 146 terminate in shoulders 150. When assembled, fan-shaped body 136 of stop clip 132 is positioned under ramp 148 as shown in FIG. 15. Ramp 148 pushes down on lug 141 of stop clip 32 and compresses the springs positioned in apertures 144 under posts 138.

When key 112 is inserted into key plug 122, as shown in FIG. 12, finger 118 of key 112 is positioned above ledge 140 of stop clip 132. As key 112 rotates, key plug 122 and stop clip 132 rotate relative to ramp 48 of face plate 124. During rotation, the springs in apertures 144 push stop clip 132 outwardly until ledge 140 of stop clip 132 engages finger 118 of key 112. Finger 118 prevents stop clip 132 from moving into valleys 146. As stop clip 132 continues to rotate with key plug 122 and key 112, finger 118 of key 112 blocks outward movement of stop clip 132 and lug 141 of stop clip 132 pass shoulders 150 of face plate 124. This permits continued rotation of key plug 122 to unlock the lock.

If a copied key without finger 118 is inserted into key plug 122 and rotated, fan-shaped body 136 of stop clip 132 will slide over ramp 148 into valleys 146. Because finger 118 is not present to block outward movement of stop clip 132, the springs will push fan-shaped body 136 completely into valleys 146 so that lug 141 of stop clip 132 abuts shoulders 150 of face plate 124 as rotation continues. This contact blocks further rotation of stop clip 132, key plug 122 and key 112 so that the lock is not unlocked. According to an alternative embodiment, shoulders 150 align with edges 142 to block further rotation of key plug 122 if finger 118 is not provided on the key.

According to another alternative embodiment, fingers 18, 188 of keys 12, 112 and/or ledges 40, 140 of stop clips 32, 132 include ramps. See, for example, ramps 145, 147 shown in phantom in FIGS. 16 and 18. These ramps come into contact with each other during insertion of keys 12, 112 into respective key plugs 22, 122.

Unless otherwise stated herein, the figures are proportional. Although the present invention has been described in detail with reference to preferred embodiments, variations and modifications exist within the scope and spirit of the present invention as described and defined in the following claims.

1. A key and lock core combination including
a lock core including
a sleeve defining an interior region,
a plug member positioned in the interior region to move relative to the sleeve, the plug member defining a key passage, and
a blocking member positioned to move between a first position blocking movement of the plug member relative to the sleeve and a second position permitting movement of the plug member relative to the sleeve, and
a key including
a key shank,
a bow, and
an extension cooperating with the key shank to define a space therebetween, the extension moving the blocking member to the second position when the key shank is inserted into the key passage.

2. The key and lock core combination of claim 1, wherein the extension of the key extends in a direction substantially parallel to the key shank.

3. The key and lock core combination of claim 1, wherein the extension of the key has a width that is less than half of a width of the key shank.

4. The key and lock core combination of claim 1, wherein the extension of the key has a polygonal cross-section.

5. The key and lock core combination of claim 1, wherein a width of the key shank is substantially equal to a width of the bow.

6. The key and lock core combination of claim 5, wherein a width of the extension is less than the width of the key shank.

7. The key and lock core combination of claim 1, wherein the key shank includes a proximal end and a distal end coupled to the bow and the extension is positioned closer to the distal end of the key shank than to the proximal end of the key shank.

8. A key for use with a lock core including a key passage, the key including
a key shank having longitudinal grooves extending a majority of the length of the key shank,
a key bow coupled to the key shank, and
an extension coupled to the key shank, the extension extending in the direction of the key shank and cooperating with the key shank to define a space therebetween.

9. The key of claim 8, wherein the key shank has a width and the extension has a width less than half the width of the key shank.

10. The key of claim 9, wherein the bow has a width substantially equal to the width of the key shank.

11. The key of claim 8, wherein the key shank includes spaced-apart first and second longitudinal surfaces, the first longitudinal surface includes bitting and the extension is positioned adjacent to the second surface.

12. The key of claim 8, wherein the key shank includes a proximal end and a distal end coupled to the bow and the extension is positioned closer to the proximal end of the key shank than to the distal end of the key shank.

13. The key of claim 8, wherein the key shank is substantially flat.

14. The key of claim 8, wherein the extension includes a proximal end and a distal end spaced apart from the key shank, the proximal end is directly coupled to the bow.

15. A key for use with a lock core including a key passage, the key including
a key shank,
a key bow coupled to the key shank and having a width substantially equal to a width of the key shank, and
an extension coupled to the key shank, the extension extending in the direction of the key shank and cooperating with the key shank to define a space therebetween.

16. The key of claim 15, wherein the key shank has a width and the extension has a width less than half the width of the key shank.

17. The key of claim 15, wherein the key shank includes spaced-apart first and second longitudinal surfaces, the first longitudinal surface includes bitting and the extension is positioned adjacent to the second surface.

18. The key of claim 15, wherein the second surface includes a detent.

19. The key of claim 15, wherein the extension has a polygonal cross-section.

20. The key of claim 15, wherein the extension is directly coupled to the bow and key shank.
